(19) United States
(12) Patent Application Publication
(10) Pub. No.: US 2010/0131210 A1
(43) Pub. Date: May 27, 2010

(54) Method and system for non-destructive inspection of a colony of stress corrosion cracks

(76) Inventors: Martin Fingerhut, League City, TX (US); Munendra Tomar, Houston, TX (US); Marvin Klein, Pacific Palisades, CA (US)

Correspondence Address: JACOBSON HOLMAN PLLC, 400 SEVENTH STREET N.W., SUITE 600, WASHINGTON, DC, 20004, US

(21) Appl. No.: 12/292,701

(22) Filed: Nov. 24, 2008

(51) Int. Cl. G01N 27/20; G01N 29/04

(52) U.S. Cl. 702/38; 73/623; 702/39

(57) ABSTRACT

The invention relates to a method and inspection system for non-destructive inspection of a colony of stress corrosion cracks in a pipe or a vessel. The method comprises mapping the colony of stress corrosion cracks, identifying at least one individual crack to be sized within the colony, and sizing the at least one individual crack to be sized.

The invention relates to a method for non-destructive inspection of a colony of stress corrosion cracks in a pipe or vessel. The invention also relates to an inspection system for carrying out a method according to the invention.

### BACKGROUND OF THE INVENTION

Several pipeline failures around the world have been attributed to Stress Corrosion Cracking (SCC) since its discovery in pipelines in the 1960's including USA, Canada, Russia, France, Saudi Arabia, Australia and South America. While the number of incidents attributed to SCC is less than those attributed to other threats to pipelines such as corrosion or mechanical damage, it constitutes a challenge due to the following reasons:

no reliable, accurate and industry-accepted in-line-inspection tools or predictive modelling based tools exist that are capable of determining what locations along the pipeline are affected by SCC;

no reliable and widely accepted assessment tools exist for evaluation of SCC, once found; and

no reliable and widely accepted tools exist that are capable of measuring the depth of these cracks accurately.

Given these limitations, development of an effective SCC mitigation plan and assessment techniques has been slow. Recent developments in Inline Inspection (ILI) technology and increasing understanding of the phenomenon seem to show promise, but the lack of a reliable non-destructive means for measuring crack depths within an SCC colony makes it difficult to develop a comprehensive approach.

Currently, there are no standard practices for managing SCC. Most operators capitalize on available literature and their experiences to devise an appropriate SCC management and mitigation plan. These practices utilize hydrostatic testing, ILI or Direct Assessment.

In-line Inspection and Direct Assessment require some means of determining the impact of SCC on the integrity of the pipe affected. While several methods have been suggested for calculating the failure pressure, none of the methods have had extensive validation using full-scale burst tests and therefore, are not widely used.

Recent results from a joint initiatives program undertaken by Major North American Operators, accepted as part of the recent CEPA Stress Corrosion Cracking Recommended Practices, utilize a system of severity ranking of SCC into four categories. The categories are defined on the basis of predicted failure pressures. The implementation of such an approach, with the exception of hydrostatic testing, requires a means for the determination of the failure pressures and by extension, a means for accurate measurement of crack lengths, crack depths, and the interlinking crack lengths for an SCC colony.

Common practice in the industry is to use Magnetic Particle Inspection for the detection of SCC at excavation locations. It enables the measurements of colony dimensions with ease. However, due to the large number of cracks that may be present in a colony, crack specific measurements such as crack lengths, mutual separation and interlinking crack lengths are practical estimates.

The application of any of the Failure pressure calculation methods for SCC utilizes crack depth data as well. No widely acceptable, proven and reliable non-destructive technology exists that is capable of measuring the depth (sizing) of SCC. Incremental grinding or buffing remains the most accurate and widely applicable means for sizing SCC as found in the field. The lack of non-destructive sizing technology is also responsible for the lack of a validated SCC evaluation method.

### SUMMARY OF THE INVENTION

It is an object of the present invention to provide an improved method for non-destructive inspection of a colony of stress corrosion cracks.

Accordingly, the invention provides a method for non-destructive inspection of a colony of stress corrosion cracks in a pipe or a vessel, comprising mapping the colony of stress corrosion cracks, identifying at least one individual crack to be sized within the colony, and sizing the at least one individual crack to be sized. Herein “sizing” refers to determining a depth of the crack. This method provides the advantage that the depth of one individual crack within the colony of stress corrosion cracks can be determined without interference from surrounding cracks within the colony. This provides a more accurate representation of the depth profile of the crack(s) identified to be sized within the colony of stress corrosion cracks, thereby enabling the prediction of the remaining strength of the affected pipe or vessel, e.g. the pipe or vessel comprising carbon steel or stainless steel. Moreover, the measured value of the depth of the individual crack allows calculation of the failure pressure of the colony.

Preferably the at least one individual crack to be sized is identified on the basis of a predetermined criterion, such as crack length. For example the longest crack may be identified as the crack to be sized. Hence, an operator independent identification of the individual crack(s) to be sized is obtained.

Preferably, the predetermined criterion is based on fracture mechanics and/or simulation. Thus, the at least one individual crack to be sized may be chosen such that it is representative for predicting a failure pressure of the stress corrosion cracking affected section of the pipe or vessel, for instance a crack or a group of cracks with a high probability of leading to failure.

Preferably, mapping the colony of stress corrosion cracks, identifying at least one individual crack to be sized within the colony, and/or sizing of the at least one individual crack to be sized is performed automatically. Hence a partially or, preferably, fully automated method may be obtained. Thus, the method can be performed autonomously by an inspection system, and may be independent of an operator.

In an embodiment, the step of sizing is performed using laser ultrasonics. Laser ultrasonics proves to be highly suited for determining the depth of an individual crack within the colony of stress corrosion crack, due to its small footprint.

In an embodiment, the step of mapping is performed using one or more non-destructive examination techniques, such as eddy current, optical imaging, flash thermography and/or radiographic tomography.

It will be appreciated that it may be preferred to perform the step of sizing using a different technique from the technique used in the step of mapping. In this way the method for non-destructive inspection of a colony of stress corrosion cracks may be optimized, e.g. with respect to speed, cost, accuracy etc., by selecting the optimum technique for mapping and the optimum technique for sizing.

In an embodiment, the method is practised on a volume of solid material that comprises a metal, such as a volume of a metal pipeline, the mapping step comprises performing a method of non-destructive inspection along a surface of the volume of solid material (e.g. electromagnetic inspection), for determining the defect pattern and/or distribution along the surface, and the sizing step comprises performing a method of ultrasonic inspection determining a depth of an individual crack associated with a defect of the defect pattern. By using this method, a rather quick overview of defects can be obtained in the mapping step, whereafter an individual defect or set of defects can be sized with high accuracy in the sizing step. The method may thus integrate the advantages of electromagnetic inspection and ultrasonic inspection into a powerful inspection method.

Preferably, the sizing, e.g. the ultrasonic inspection, is performed only over part of the surface that is inspected by the mapping, e.g. the electromagnetic inspection. More preferably, the sizing is performed only adjacent to, close to, and/or near the individual crack(s) to be sized determined by the mapping and subsequent application of a predetermined criterion. In particular, the sizing is performed only for a selection of the defects of the defect pattern determined by the mapping.

Preferably, the mapping, e.g. the electromagnetic inspection, and the sizing, e.g. the ultrasonic inspection, are carried out as a combined scan step, for example substantially at the same time or substantially without waiting time between both methods. Each one of such spatial and temporal limitations on performing the sizing and/or the mapping reduce the inspection time of the method according to the invention.

In an embodiment, a frequency of the applied electromagnetic field in the solid material in the mapping step is varied at or adjacent to the inspection location. Preferably, a plurality of electromagnetic responses are received at or adjacent to the inspection location, influenced by one and the same part of the volume of solid material. This enables an estimate of the defect depth being larger than a predetermined value, thereby allowing a short listing of defects (cracks) that would not be significant enough to affect the strength of the structure

It is another object of the present invention to provide an improved system for carrying out the improved method.

Accordingly, the invention provides an inspection system for non-destructive inspection of a colony of stress corrosion cracks in a pipe or a vessel, comprising a mapping detector for mapping the colony of stress corrosion cracks and arranged for outputting mapping data representative of the colony, a processing unit for identifying at least one individual crack within the colony on the basis of the mapping data, and a sizing detector for sizing of the at least one individual crack.

Different parts of the inspection system may be separate from one another, for example the mapping detector may be separate from, and may be arranged to function independently from, the sizing detector. Preferably, the mapping detector and the sizing detector are integrated into a single inspection device.

In an embodiment, the volume of solid material is comprised by a pipe(line) or a vessel such as a storage tank, and the inspection system comprises positioning means for positioning the mapping detector and/or sizing detector with respect to the pipe or vessel, preferably in two mutually transverse directions with respect to the pipe or vessel. The two mutually transverse directions may be directed in a longitudinal direction of the pipe or vessel and in a circumferential direction of the pipe or vessel, respectively.

### BRIEF DESCRIPTION OF THE DRAWINGS

The invention will be described by, non-limiting, examples in reference to the accompanying drawing, wherein:

FIG. 1 shows a schematic representation of an embodiment of an inspection device according to the invention;

FIG. 2A shows an example of a conductivity pattern;

FIG. 2B shows an enlarged view of two other fractures and corresponding distances x and y;

FIG. 3 shows an example of bulk ultrasonic signals generated in a solid material by using an exciting laser beam;

FIG. 4A shows schematically an example of a Time-of-Flight-Diffraction (ToFD) measurement method of a fracture that extends into the solid material from a surface of the solid material;

FIG. 4B shows schematically an example of a Crack-Tip-Diffraction (CTD) measurement method of the fracture that extends into the solid material from the surface of the solid material;

FIG. 4C shows a sub-surface fracture;

FIGS. 5A and 5B show scan methods in a top plan view of a surface of the solid material;

FIG. 6 shows an example of a sizing detector in an embodiment of an inspection system according to the invention, a pipeline; and

FIG. 6A shows a plot of fracture depth

FIG. 7 shows a schematic representation of an example of a method for non-destructive inspection of a colony of stress corrosion cracks according to the invention.

### DETAILED DESCRIPTION OF THE INVENTION

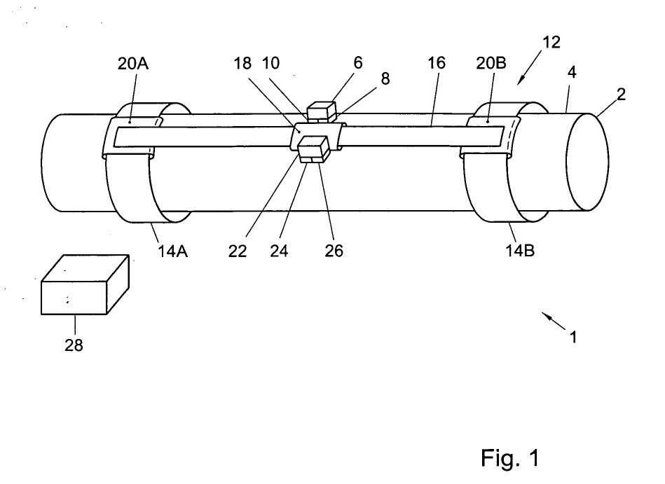

FIG. 1 shows a schematic representation of an embodiment of an inspection system 1 for non-destructive inspection of a colony of stress corrosion cracks in an object. In this example the object is a carbon steel or stainless steel pipe 2. The pipe may e.g. be part of a pipeline, such as a pipeline for natural gas or crude oil. The object may also be a vessel such as a column or storage tank, e.g. in a chemical plant. The object in this example thus has a steel wall 4.

The inspection system 1 comprises a mapping detector 6 for mapping the colony of stress corrosion cracks. In this example, the mapping detector 6 comprises an electromagnetic mapping detector comprising a first electromagnetic transducer 8 for applying an electromagnetic field in the steel wall 4, and a second electromagnetic transducer 10 for receiving a resulting electromagnetic response of the steel wall 4. The electromagnetic mapping detector 6 is arranged for outputting mapping data representative of the detected electromagnetic response. More in general, the mapping detector 6 is arranged for outputting mapping data representative of a mapped colony of stress corrosion cracks.

The inspection system 1 in FIG. 1 includes a scan frame 12. In this example the scan frame 12 comprises two clamps 14A, 14B which are mounted, e.g. clamped, onto the pipe 2. The scan frame 12 further comprises a beam 16. In this example the scan frame 12 comprises first positioning means 18 for positioning the mapping detector 6 in an axial direction of the pipe 2. In this example, the first positioning means 18 comprise a carriage movably connected to a guide rail of the beam 16. Here, the first positioning means 18 also comprises a drive unit, such as an electric motor for positioning the first positioning means 18. Preferably, the first positioning means 18 also comprise a position detector, such as a linear encoder, for determining an absolute or relative position of the carriage with respect to the clamps 14A,14B.

The scan frame 12 further comprises second positioning means 20A,20B for positioning the beam 16, and hence the mapping detector 6 in a tangential direction of the pipe 2. Thus the mapping detector 6 is positionably mounted to the scan frame 12 for scanning the mapping detector across a surface of the steel wall 4 of the pipe 2. In this example, the second positioning means 20A,20B each comprise a carriage movably mounted to a circumferential guide rail of the clamp 14A,14B. Here, each of the second positioning means 20A,20B also comprises a drive unit, such as an electric motor for positioning the second positioning means 20A,20B. Preferably, the respective drive units of the second positioning means are mutually synchronised. Preferably, the second positioning means 20A,20B also comprise a position detector, such as a linear encoder, for determining an absolute or relative position of the carriage with respect to a circumference of the pipe 2.

The inspection system 1 further comprises a sizing detector 22. The sizing detector is arranged for sizing an individual crack within a colony of stress corrosion cracks. In this example the sizing detector comprises an exciting laser 24 for generating a ultrasonic waves in the wall 4. The exciting laser 24 can be formed by a pulsed laser, for example a pulsed Nd:YAG laser, for example with a wavelength of 1064 nm, a pulse length of 10 ns, a pulse energy of 50 mJ and a pulse repetition rate of 10 Hz. The sizing detector 22 in this example further comprises a detection laser 26 for detecting an ultrasonic response of the wall 4 to the ultrasonic wave generated by the exciting laser 24. Unlike conventional ultrasonic testing, Laser Ultrasonics has a large frequency bandwidth and a tiny (˜0.5 mm) footprint. These characteristics make it ideally suited for application as a depth sizing tool for closely-spaced cracks in a colony. Laser Ultrasonics provides the ability to size an individual crack within the colony without interference from surrounding cracks within the colony.

In this example, the sizing detector 22 is also mounted to the first positioning means 18 and can hence also be scanned across the surface of the steel wall 4 of the pipe 2. It will be appreciated that it is also possible that the scan frame 12 comprises separate positioning means for the mapping detector 6 and for the sizing detector 22 for independently scanning the mapping detector 6 and the sizing detector 22.

In FIG. 1 the inspection system 1 further comprises a processing unit 28. The processing unit 28 is arranged for controlling the first and second positioning means 18,20A,20B. Thus, the processing unit 28 can position the mapping detector 6 and/or sizing detector 22 between the clamps 14A,14B. The processing unit is further arranged for receiving the mapping data from the mapping detector 6.

It will be appreciated that the inspection system 1 shown in FIG. 1 is designed as an in-line-inspection tool, wherein the mapping detector, sizing detector, positioning means and scan frame are integrated. It will be appreciated that the processing unit is communicatively connected to the remainder of the system 1 and can be physically connected to the remainder of the system if desired.

The inspection system 1 described thus far can be used in a method for non-destructive inspection of a colony of stress corrosion cracks in a pipe or vessel according to the following first example.

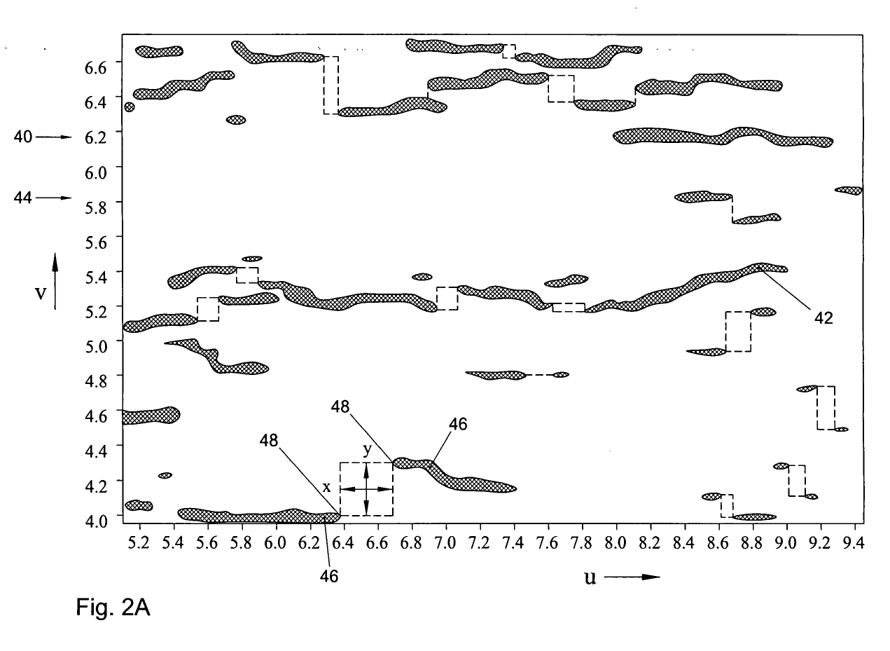

In this example, the method starts with the mapping detector 6 scanning at least a part of the wall 4 for mapping the colony of stress corrosion crack. The mapping detector 6 is moved by the first and second positioning means 18,20A,20B. The mapping detector 6 may e.g. be moved in the axial direction for a number of consecutive tangential positions. In this example, the mapping detector only maps the wall 4 while moving in one direction for avoiding hysteresis effects. In this way, a defect pattern can be determined by the mapping detector 6, wherein the defect pattern includes defect locations and/or defect geometries along the surface of the wall 4. The defect geometry may include a length of the defect, a width of the defect, and/or a shape of the defect. The defects in the defect patter may e.g. be associated with locations where stress corrosion cracks are present in the wall 4. The mapping data output by the mapping detector 6 may for instance comprise a table of coordinates at which defects have been detected. If the wall 4 comprises a colony of stress corrosion cracks, the mapping detector 6 will also output mapping data representative of the colony. An example of a defect pattern is described below with respect to FIG. 2.

Then, in this example, the processing unit 28, analyses the mapping data and identifies the individual crack or cracks to be sized in the colony. The crack(s) to be sized may e.g. be determined on the basis of a length of a defect in the defect pattern determined by the mapping detector 6. In this example, the processing unit identifies the longest defects in the defect pattern as the individual crack to be sized. Additionally, or alternatively, interaction rules between cracks may be used in determining which crack or cracks in the colony need be sized, or e.g. interlinking crack lengths (lengths between cracks prone to merge). It is also possible that the crack(s) to be sized is (are) determined on the basis of expected relevance of that crack on the local wall strength, e.g. on the basis of fracture mechanics and/or numerical simulation. It is possible to identify the crack(s) with a high probability of leading to failure as the crack(s) to be sized. Also, the processing unit 28 may be arranged to identify a predetermined number of individual cracks to be sized, e.g. the largest crack, or the largest five cracks of the colony.

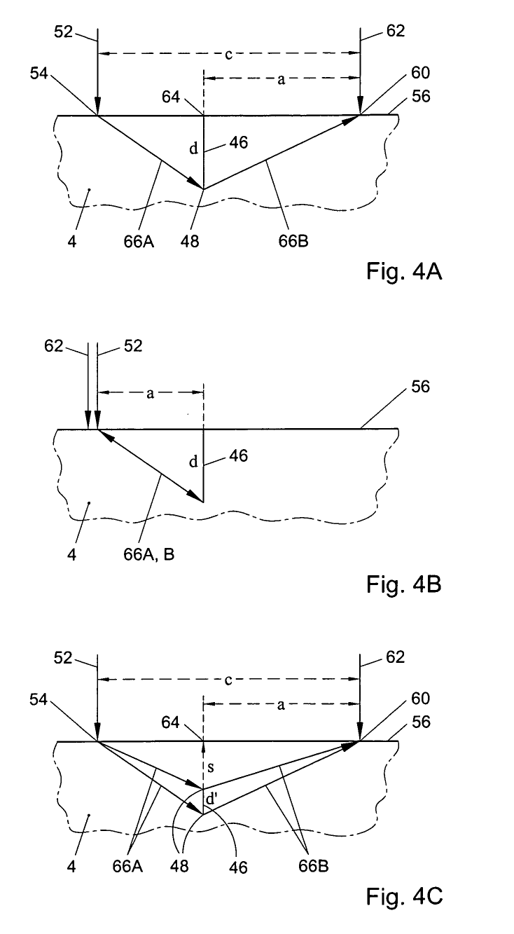

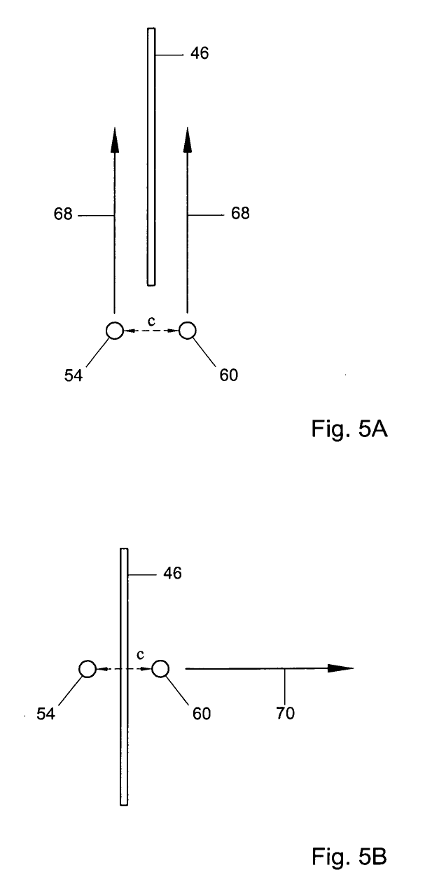

Next, the inspection system 1 positions the sizing detector 22 at or adjacent the crack to be sized and sizes that crack. It will be appreciated that the sizing detector 22 may be moved towards the individual crack to be sized at a greater speed than at which the sizing detector 22 is moved while sizing the crack to be sized. Here sizing the individual crack indicates determining the depth of the individual crack. Examples of how the individual crack can be sized are described with respect to FIGS. 4A-5B. If a plurality of individual cracks within the colony are to be sized, the inspection system positions the sizing detector adjacent these cracks consecutively.

Once the individual crack(s) to be sized has(have) been sized, data representative of the determined crack depth(s) can be stored into memory and/or further processed, e.g. for predicting, e.g. calculating, the failure pressure. It is also possible to measure crack length and/or interlinking crack length using the mapping detector and/or sizing detector, e.g. for calculating the failure pressure. The determined crack depth(s) and/or the calculated failure pressure may provide a quantitative indication of the safety risk posed by the inspected colony of stress corrosion cracks. The failure pressure may give a quantitative indication of the remaining strength of the affected wall 4.

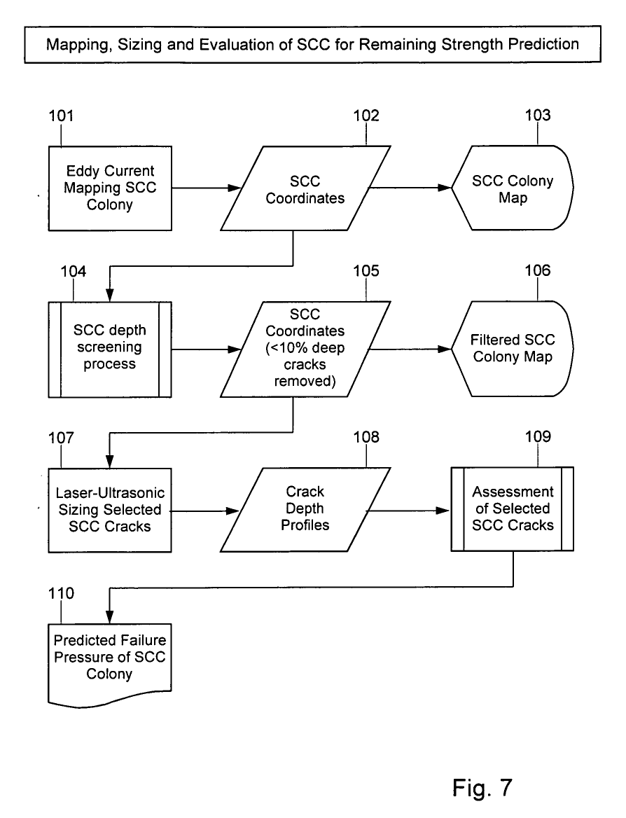

FIG. 7 shows a schematic representation of a second example of a method for non-destructive inspection of a colony of stress corrosion cracks, e.g. in a pipe or vessel, according to the invention.

In this example, the method starts with the mapping detector 6, here an eddy current detector, scanning at least a part of the wall 4 for mapping (101) the colony of stress corrosion crack. In this way, again a defect pattern can be determined by the mapping detector 6. Here the mapping detector 6 outputs a table of coordinates (102) at which defects have been detected. If the wall 4 comprises a colony of stress corrosion cracks, the mapping detector 6 will also output mapping data representative of the colony (103), e.g. in the form of an SCC colony map.

Then, in this example, the processing unit 28, analyses the mapping data and identifies the individual crack or cracks to be sized in the colony. The crack(s) to be sized are in this example determined (104) on the basis of a depth of a defect in the defect pattern as determined by the mapping detector 6. In this example, the processing unit identifies the deepest defects in the defect pattern as the individual crack to be sized. Additionally, or alternatively, interaction rules between cracks may be used in determining which crack or cracks in the colony need be sized, or e.g. interlinking crack lengths (lengths between cracks prone to merge). The processing unit filters (106) the SCC colony map to remove (105) less relevant cracks.

Next, the inspection system 1 positions the sizing detector 22, here the laser ultrasonics sizing detector, at or adjacent the selected cracks to be sized and sizes these selected cracks (107). Once the selected individual cracks to be sized have been sized, data representative of the determined crack depths can be provided as crack depth profiles (108). Next, the data representative of the determined crack depths can be assessed (109) and a predicted failure pressure of the SCC colony can be calculated (110).

In general, the method comprises the steps of mapping a colony of stress corrosion cracks, identifying at least one crack within the colony of stress corrosion cracks, and sizing the at least one crack. It will be appreciated that the processing unit 28 may be arranged for identifying at least one individual crack within the colony of stress corrosion cracks which at least one individual crack should be sized using the sizing detector 22. The processing unit 28 may identify such relevant crack to be sized on the basis of the mapping data received from the mapping detector 6. It will be appreciated that the processing unit may also comprise a number of separate units, some of which may be integrated with the mapping detector 6 and/or the sizing detector 22.

In the above examples, the inspection system 1 automatically performs the steps of mapping a colony of stress corrosion cracks, identifying at least one crack within the colony of stress corrosion cracks, and sizing the at least one crack. Thus, an automated measurement method is obtained.

It will be clear that such automated mapping and sizing provides the advantage that only individual cracks fulfilling objective criteria, i.e. cracks identified as cracks to be sized by the processing unit 28, will be sized, which reduces inspection time. Also, automatically determining which individual cracks in the colony need to be sized reduces inspection time, as interpretation by an operator is not required, and enhances reproducibility of the inspection.

In these examples, the step of mapping the colony of stress corrosion cracks includes positioning the first electromagnetic transducer 8 at or adjacent to an inspection location of the surface of the wall 4, and applying an electromagnetic field in the wall 4 by using the first electromagnetic transducer 8. Applying the electromagnetic field, for example as an electromagnetic pulse, may result in an eddy current in the wall 4. The eddy current will decay and diffuse away from the first electromagnetic transducer 8 into the wall 4, and create a magnetic field as a resulting electromagnetic response of the wall 4.

In addition, in these examples the step of mapping the colony of stress corrosion cracks includes positioning the second electromagnetic transducer 10 at or adjacent to the inspection location, and receiving the resulting electromagnetic response of the wall 4 using the second electromagnetic transducer 10. The first electromagnetic transducer 8 may be integrated with the second electromagnetic transducer 10 into an integrated mapping detector 6 as shown in FIG. 1. The mapping detector 6 may include a meandering conducting structure integrated on a flexible foil. An example of such an integrated sensor is disclosed in U.S. Pat. No. 5,966,011.

Here, the step of identifying at least one crack within the colony of stress corrosion cracks includes inferring from the electromagnetic response an electromagnetic conductivity of the wall 4. A, e.g. numerical, model for the electromagnetic response may be used wherein the electromagnetic conductivity is a parameter of the model. Such a model is known to the person skilled in the art. By adjusting the parameter that represents the electromagnetic conductivity to match a model response with a measured response, the electromagnetic conductivity can be inferred.

A frequency of the applied electromagnetic field in the solid material may be varied at or adjacent to the inspection location. The frequency may, for example, be in a range from 50 kHz to 250 kHz, for example approximately equal to 130 kHz, within a range of ±10%.

In these examples, the step of mapping the colony of stress corrosion crack comprises positioning the first electromagnetic transducer, applying the electromagnetic pulse, positioning the second electromagnetic transducer, receiving the electromagnetic response, and inferring the electromagnetic conductivity for a plurality of measuring locations along the surface of the wall 4. In this way, a defect pattern can be inferred from the conductivity pattern, wherein the defect pattern includes at least defect locations and defect geometries along the surface. A defect geometry may include a length of the defect, a width of the defect, and/or a shape of the defect. The defects in the defect patter may e.g. be associated with locations where stress corrosion cracks are present in the wall 4.

FIG. 2A shows an example of a conductivity pattern 40, as a function of a plurality of inspection locations represented by coordinates u, v along the surface of the wall 4. Dark-coloured regions 42 in the conductivity pattern 40 refer to relatively low conductivity, which are associated with defects constituting the defect pattern 44. In this example, the defects of the defect pattern approximately coincide with the regions 42 of low conductivity, so that the defect pattern 44 approximately coincides with the conductivity pattern 40.

The step of identifying at least one crack to be sized may include applying an interaction criterium to at least two defects 46 of the defect pattern, for determining whether the at least two defects 46 are interacting. Thereto two distances x and y are defined, that form a box whose opposing corners are approximately coinciding with neighbouring ends of the defects 46, for example neighbouring fracture tips 48 of two cracks, also termed fractures 46.

FIG. 2B shows an enlarged view of two other fractures 46 and the corresponding distances x and y. The fractures have a length indicated by l₁ and 12, respectively. In general, an interaction criterium may be that the fractures 46 are interacting if y≦0.14(l₁+l₂)/2 and if x≦0.25(l₁+i₂)/2. Such interacting fractures 46 in general increase a risk for extension of the fractures 46 in the wall 4.

In these examples, the step of sizing a crack in the colony of stress corrosion cracks includes performing ultrasonic inspection for determining a size of the defect of the defect pattern in a direction transverse to the surface of the wall 4, i.e. determining the depth of that crack. The method of ultrasonic inspection may include selecting the defect from the defect pattern and determining the location of the defect from the defect pattern, and generating a bulk ultrasonic signal in the solid wall 4 at a first position adjacent to the location of the defect. Generating the bulk ultrasonic signal may include applying an excitation laser beam at the first position using the exciting laser 24.

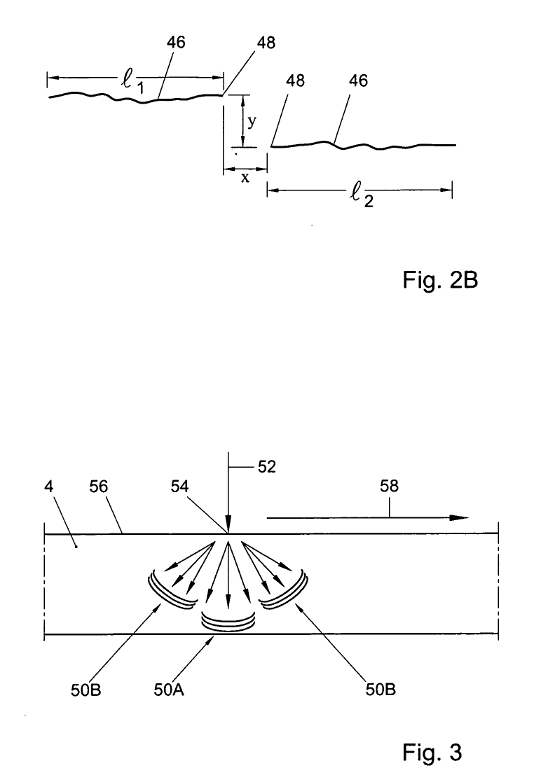

FIG. 3 shows an example of the bulk ultrasonic signals, in this example ultrasonic waves 50A and 50B, generated in the solid material wall 4 by using the excitation laser beam 52. The excitation laser beam 52 is applied at a first position 54 on the surface 56 of the wall 4. A diameter of the excitation laser beam at the first position 54 may be in a range of 0.02 mm to 5 mm, for example 0.1 mm. The bulk ultrasonic waves 50A predominantly comprise longitudinal waves, while the bulk ultrasonic waves 50B predominantly comprise transversal waves. In general, surface waves 58 will also be generated

In this example, the step of sizing the individual crack further includes measuring a bulk ultrasonic response signal at a second position adjacent to the location of the defect. The bulk ultrasonic response signal originates from the bulk ultrasonic signal by interaction with the defect in the volume of wall 4. In addition, sizing may include determining at least a first time difference from a moment of generation of the bulk ultrasonic signal at the first position to a moment of arrival of the bulk ultrasonic response signal at the second position, and determining a size of the defect transverse to the surface using at least the first time difference.

In general, the sizing may include a Time-of-Flight-Diffraction (ToFD) measurement. FIG. 4A schematically shows an example of the ToFD measurement of the defect 46, for example a fracture 46, that extends into the wall 4 from the surface 56 of the wall 4, transverse to the surface 56. Ultrasonic waves, like the ultrasonic waves 50A and 50B in FIG. 3, are generated in the wall 4 for example by using the excitation laser beam 52. The ultrasonic waves are diffracted at a tip 48 of the fracture 46, and subsequently received at a second position 60. At the second position 60, measuring the bulk ultrasonic response signal, in this case the diffracted ultrasonic waves, can be carried out by using a sensing laser beam 62 generated by the detection laser 26. A diameter of the sensing laser beam at the second position 60 may be in a range of 0.02 mm to 5 mm, for example 0.1 mm. The diffracted ultrasonic waves are an example of a bulk ultrasonic response signal that originates from the bulk ultrasonic signal, for example the transversal ultrasonic waves 50B from FIG. 3, by interaction with the defect, in this example the fracture 46 that extends from the surface 56 into the wall 4.

According to the ToFD method, the size of the fracture 46, in this example the fracture depth d, can now be determined. In order to do this, a first distance c from the first position to the second position can be determined. In addition, or as an alternative, for example a second distance a is determined from the second position 60 to a fracture location 64, being an example of the defect location, in this example the position of the fracture 46 at the surface 56. The first distance c and/or the second distance a can for example be determined by visual inspection, for example by using a ruler. The first distance c and/or the second distance a can also be determined automatically by using ultrasonic waves, for example the surface waves 58. Determining the second distance a in addition to determining the first distance c can also be omitted, for example by positioning the excitation laser beam 52 and the sensing laser beam 62 such that the first and second position 54 and 60 are at substantially equal distances from the fracture location 64. Alternatively, the fracture location 64 can for example be assumed to be at substantially equal distances from the first and second position 54 and 60, while substantially ignoring the actual fracture location 64 between the first and second position 54 and 60. The depth d determined by the ToFD method is relatively insensitive for an error in fracture location 64 made in this way.

In addition, the first time difference from the moment of generation of the bulk ultrasonic signal at the first position 54 to the moment of arrival of the bulk ultrasonic response signal at the second position 60 can be determined. From the first time difference and known or predetermined velocities of the bulk ultrasonic waves 50A and/or 50B in the wall 4, a summed length of a ray path 66A and a ray path 66B of respectively the generated bulk ultrasonic signal and the bulk ultrasonic response signal that originates from the bulk ultrasonic signal, can be determined. In order to do this, an orientation and shape of the fracture 46 is assumed. In first order, it is assumed that the fracture 46 is oriented perpendicularly to the surface 56 and has a planar shape. However, if a-priori information about the fracture orientation and shape is available, for example as a result of a dominant stress loading of the wall 4 in use, or as a result of analysing other fractures in the wall 4, another orientation and/or shape can be assumed. By combination of the summed length of the ray path 66A and 66B, the first and second distance c and a, a size, in this case the depth d, of the fracture 46 can be determined. This can be done using mathematical methods known as such to the person skilled in the art.

The detection laser 26 is in this example a Nd:YAG Diode-Pumped Solid-State (DPSS) laser, for example with a wavelength of 532 nm and a power of 200 mW. Preferably, the bulk ultrasonic response signal is retrieved from the signal carried by the sensing laser beam 62 by demodulation. Alternatively, or additionally, the bulk ultrasonic response signal is retrieved by using an optical interferometer, that makes use of the sensing laser beam 62. Alternatively or additionally, the bulk ultrasonic response signal may also be received by using a piezoelectric ultrasonic transducer.

In general, the sizing may include a Crack-Tip-Diffraction (CTD) measurement method. FIG. 4B schematically shows an example of the CTD measurement method of the fracture 46 that extends into the wall 4 from the surface 56 of the wall 4, transverse to the surface 56. In this method, the first position 54 and the second position 60 can substantially coincide. Also, the first distance c is substantially equal to zero. This CTD method can form an alternative or an addition to the ToFD method of FIG. 4A. Determination of the fracture depth d is carried out analogously to determination of the fracture depth d in FIG. 4A, with the difference that the excitation laser beam 52 and the sensing laser beam 62 are positioned at the same side with respect to the fracture 46.

Determining the first and second distance c and a may also both be omitted. This can be done for example if the first distance c and/or the second distance a are known, for example by being predetermined. Also, this can be done for example when the fracture depth d is much larger than the first distance c. This can be relevant for example when a fracture 46 has a separation to surrounding defects of the defect pattern that is much smaller than the depth d of the fracture 46, so that the first and second position are chosen relatively close to the fracture location 64.

The sizing can also include determining a second time difference, from a moment of generation of the bulk ultrasonic signal at the first position 54 to a moment of arrival of another bulk ultrasonic response signal at the second position 60. The first time difference in general is different from the second time difference if the other response signal related to the second time difference is caused by another part of the defect, for example another fracture tip, than the response signal related to the first time difference.

FIG. 4C shows a sub-surface fracture 46. The bulk ultrasonic signal travels along ray paths 66A, and the response signal 66B and the other response signal are caused by opposing fracture tips 48. Information about a size of the sub-surface fracture 46, for example a depth d′ of the sub-surface fracture 46 in a direction perpendicular to the surface 56, can be obtained by determining a difference between the first time difference and the second time difference. In combination with a distance s from the sub-surface fracture 46 to the surface 56, and the first distance c, the depth d′ of the sub-surface fracture may be determined or estimated using mathematical methods known as such to the person skilled in the art.

In general, methods for determining the depth d of the fracture 46 described with reference to FIGS. 4A, 4B, and 4C, may be applied for determining depths (s+d′ ) and s related respectively to the first time difference and the second time difference, after which for example the depth d′ of the sub-surface fracture can be determined by determining a difference of the depths related to the first time difference and the second time difference.

After determining the fracture depth d or d′, the fracture may be grinded out. The depth of the fracture determined by grinding out can be compared with the fracture depth d or d′ determined as described with reference to FIGS. 4A, 4B, and/or 4C.

When applying the ToFD or CTD method of FIGS. 4A and 4B, information about the summed length of the ray path 66A and 66B, or about one or more of the individual ray paths 66A and 66B, may be obtained by combining information of a moment of arrival of a transversal wave and a longitudinal wave from the fracture tip 48. In particular, by using known or predetermined transversal- and longitudinal wave velocities and assuming that the moment of diffraction of both waves is equal, the length of the ray path 66B can be determined from another time difference from the moment of arrival of the longitudinal wave to the moment of arrival of the transversal wave. The fracture depth d can now be determined from the second distance a and the length of the ray path 66B. In this way a determination or verification of the fracture depth d can be carried out.

FIGS. 5A and 5B show scan methods in a top plan view of the surface 56 of the wall 4, that may be included by the method of ultrasonic inspection. During the scan method of FIG. 5A, the first and second position 54 and 60 are moved in a first scan direction, indicated by the arrows 68, substantially parallel to and along the fracture 46, which extends into the wall 4 from the fracture location 64. The scan method of FIG. 5A is an example of a straddle B-scan. A beam separation equal to the first distance c from the first position 54 to the second position 60 remains substantially unchanged during scanning. By making a straddle B-scan according to FIG. 5A, a length of the fracture in the direction of the arrows 68 can also be determined. It will be appreciated that if the fracture extends at an angle with respect to the axial direction of the pipe, and/or comprises a bend, this may already be identified in the defect pattern identified by the mapping detector 22, so that the sizing detector 22 may be scanned along the fracture in the direction in which the fracture actually extends (locally). Thus, the laser may follow the specific path of the fracture.

During the scan method of FIG. 5B, the excitation laser beam 52 and the sensing laser beam 62, and as a result also the first and second position 54 and 60, are moved in a second scan direction, indicated by the arrow 70. This second scan direction is directed transverse to the fracture 46 that extends into the wall 4 from the fracture location 64. The scan method of FIG. 5B is an example of a separation B-scan. The first distance c from the first position 54 to the second position 60 remains substantially unchanged during scanning.

During the scan methods of FIGS. 5A and 5B, at regular positions along the first scan direction 68 respectively the second scan direction 70 an ultrasonic signal is generated and subsequently a bulk ultrasonic response signal that originates from the bulk ultrasonic signal by interaction with, for example by diffraction from, the defect, is measured. Subsequently measured bulk ultrasonic response signals can be plotted as a function of position along the first scan direction 68 and/or the second scan direction 70, to obtain one or more stacked B-plots. Such a stacked B-plot enables accurate determination of travel times and interpretation of measured signals.

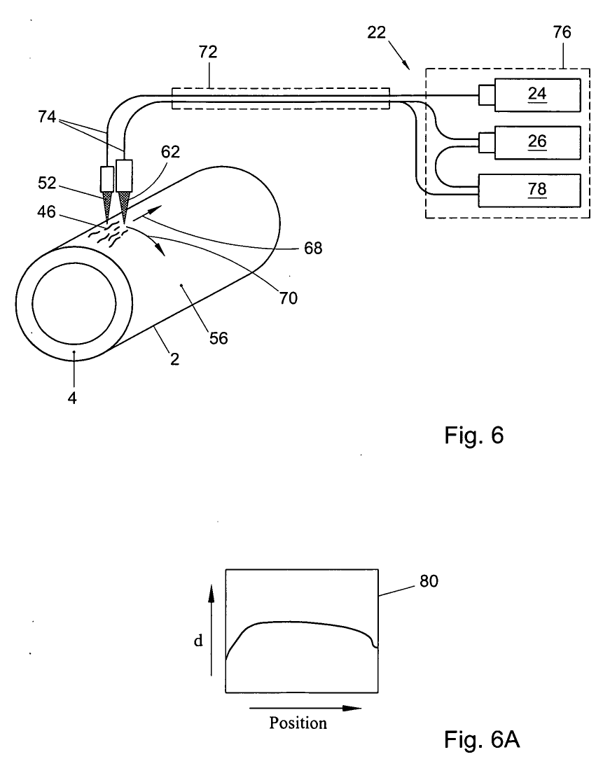

FIG. 6 shows an example of a sizing detector 22 in an embodiment of an inspection system 1 according to the invention. In this example, the wall 4 is included by the pipe 2 having the fracture 46. The surface 56 of the pipeline can be scanned in one or two of the shown scan directions 68 and 70, which are transverse to one another. In this example, the fracture 46 is one individual crack in a colony of stress corrosion cracks. The orientation of the fracture 46 in the pipe 2 in FIG. 6 is parallel with a longitudinal direction of the pipe 2. Alternatively, it can for example also have an orientation perpendicular to a longitudinal direction of the pipeline, or another orientation. The methods described with reference to FIGS. 4A, 4B, 4C, 5A, and 5B are illustrated using a flat surface 56. However, it will be clear how a curvature of a surface can be taken into account when determining the depth d of the fracture using the methods described with reference to FIGS. 4A, 4B, 4C, 5A, and 5B in conjunction with a curved surface, such as the surface 56 of the pipe 2.

The excitation laser beam 52 and the sensing laser beam 62 are applied at a mutual distance, being equal to the first distance c in FIGS. 4A, 4C, 5A, and 5B. This mutual distance can be chosen based on one or more of an expected depth of the fracture 46, a position of neighbouring fractures to the fracture 46, and obstacles (not shown in FIG. 6) that may hinder entrance of the laser beams 52, 62 to part of the surface 56 adjacent to the fracture 46. Here the sizing detector 22 is arranged to determine the first distance, for example by using infrared distance measurement, or by ultrasonic means such as by measuring a travel time of an acoustic surface wave. The sizing detector 22 in this embodiment includes a fiber umbilical 72 including optical fibers 74 that guide the laser beams 52, 62 from a base station 76, also being included by the sizing detector 22. The base station 76 includes the exciting laser 24 and the sensing laser 26. In this example, the base station 76 also includes a demodulator 78 that is arranged to demodulate a signal received from the sensing laser 26, from which the bulk ultrasonic response signal can be retrieved. The base station 76 can also be provided with a signal processor for determining the first time difference and/or for determining the depth d of the fracture according to one of the methods described here above.

FIG. 6A shows a plot 80 of fracture depth d against position along the surface along the first scan direction 68, for example obtained by making a straddle B-scan. A length of the fracture can be also be determined from such a plot. The sizing detector 22 may for example be arranged to provide such a plot 80.

In the foregoing specification, the invention has been described with reference to specific examples of embodiments of the invention. It will, however, be evident that various modifications and changes may be made therein without departing from the broader spirit and scope of the invention as set forth in the appended claims.

In the examples, the mapping detector is arranged for inducing and detecting eddy currents, however, other techniques are suitable for the mapping detector. The mapping detector may e.g. be designed as an optical imaging apparatus, flash thermography apparatus and/or radiographic tomography apparatus.

Due to the small footprint of the exciting laser beam on the wall, laser ultrasonic detection is presently preferred for the sizing detector. Nevertheless, other sizing techniques may be suitable for sizing the individual crack within the colony of stress corrosion cracks.

However, other modifications, variations and alternatives are also possible. The specifications, drawings and examples are, accordingly, to be regarded in an illustrative rather than in a restrictive sense.

In the claims, any reference signs placed between parentheses shall not be construed as limiting the claim. The word ‘comprising’ does not exclude the presence of other features or steps then those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to advantage.

1. A method for non-destructive inspection of a colony of stress corrosion cracks in a pipe or a vessel, comprising:
mapping the colony of stress corrosion cracks,
identifying at least one individual crack to be sized within the colony, and
sizing the at least one individual crack to be sized.

2. The method according to claim 1, wherein mapping the colony of stress corrosion cracks, identifying at least one individual crack to be sized within the colony, and/or sizing the at least one individual crack to be sized is performed automatically.

3. The method according to claim 1, wherein the step of identifying at least one individual crack comprises identifying the at least one individual crack to be sized on the basis of a predetermined criterion.

4. The method according to claim 3, wherein the predetermined criterion is based on fracture mechanics and/or simulation.

5. The method according to claim 1, wherein the at least one individual crack to be sized is representative for predicting a failure pressure of the stress corrosion cracking affected section of the pipe or vessel.

6. The method according to claim 1, wherein the step of sizing is performed using laser ultrasonic detection.

7. The method according to claim 1, wherein the step of mapping is performed using electromagnetic defect detection, such as eddy current defect detection, optical imaging, flash thermography and/or radiographic tomography.

8. The method according to claim 1, wherein the pipe or vessel comprises carbon steel or stainless steel.

9. The method according to claim 1, wherein the step of mapping includes:
a) positioning a first electromagnetic transducer at or adjacent to an inspection location of the surface of the pipe or vessel, and applying an electromagnetic field in the wall of the pipe or vessel by using the first electromagnetic transducer,
b) positioning a second electromagnetic transducer at or adjacent to the inspection location, and receiving a resulting electromagnetic response of the wall using the second electromagnetic transducer,
c) inferring from the electromagnetic response an electromagnetic conductivity of the wall,
d) inferring a conductivity pattern along the surface by carrying out steps a)-c) for a plurality of measuring locations along the surface, and
e) determining a defect pattern from the conductivity pattern, wherein the defect pattern includes defect locations and/or defect geometries along the surface;
and/or wherein the step of identifying includes:
f) selecting a defect from the defect pattern, determining the location of the defect from the defect pattern;
and/or wherein the step of sizing includes:
g) generating a bulk ultrasonic signal in the wall at a first position adjacent to the location of the defect,
h) measuring a bulk ultrasonic response signal at a second position adjacent to the location of the defect, wherein the bulk ultrasonic response signal originates from the bulk ultrasonic signal by interaction with the defect in the wall,
i) determining at least a first time difference from a moment of generation of the bulk ultrasonic signal at the first position to a moment of arrival of the bulk ultrasonic response signal at the second position; and
j) determining a size of the defect transverse to the surface using the at least first time difference,
wherein steps g) and h) include at least one of applying an exciting laser beam at the first position when carrying out step g) and applying a sensing laser beam at the second position when carrying out step h).

10. The method according to claim 6, wherein the size of the crack to be sized is determined according to at least one of a time-of-flight diffraction method and a crack-tip-diffraction method.

11. The method according to claim 6, including making one or more of a straddle B-scan, a separation B-scan and a stacked B-scan.

12. The method according to claim 1, including grinding-out part of the wall at the location of the crack to be sized.

13. An inspection system for non-destructive inspection of a colony of stress corrosion cracks in a pipe or a vessel, comprising:
a mapping detector for mapping the colony of stress corrosion cracks and arranged for outputting mapping data representative of the colony,
a processing unit for identifying at least one individual crack within the colony on the basis of the mapping data, and
a sizing detector for sizing of the at least one individual crack.

14. The inspection system according to claim 13, wherein the mapping detector is arranged for automatically mapping the colony of stress corrosion cracks, the processing unit is arranged for automatically identifying the at least one individual crack to be sized within the colony, and/or the sizing detector is arranged for automatically sizing of the at least one individual crack to be sized.

15. The inspection system according to claim 13, wherein the processing unit is arranged for identifying the at least one individual crack to be sized on the basis of a predetermined criterion.

16. The inspection system according to claim 15, wherein the predetermined criterion is based on fracture mechanics and/or simulation.

17. The inspection system according to claim 13, wherein the at least one individual crack to be sized is representative for predicting a failure pressure of the stress corrosion cracking affected section of the pipe or vessel.

18. The inspection system according to claim 13, comprising positioning means for positioning the mapping detector and/or sizing detector with respect to the pipe or vessel.

19. The inspection system according to claim 13, wherein the sizing detector comprises an exciting laser for generating an ultrasonic signal in a wall of the pipe or vessel, and optionally a detection laser for detecting an ultrasonic response of the wall to the ultrasonic signal generated by the exciting laser.

20. The inspection system according to claim 13, wherein the mapping detector comprises an electromagnetic defect detection apparatus, such as eddy current defect detection apparatus, an optical imaging apparatus, a flash thermography apparatus and/or a radiographic tomography apparatus.

21. The inspection system according to claim 20, wherein the mapping detector comprises a first electromagnetic transducer for applying an electromagnetic field in the wall of the pipe or vessel, and a second electromagnetic transducer for receiving a resulting electromagnetic response of the wall.

22. The inspection system according to claim 21, wherein the first electromagnetic transducer is integrated with the second electromagnetic transducer, possibly including a meandering conducting structure integrated on a flexible foil.

23. The inspection system according to claim 13, wherein the pipe or vessel comprises carbon steel or stainless steel.

24. The inspection device according to claim 18, wherein the processing unit is arranged for inferring from the electromagnetic response the electromagnetic conductivity of the wall, for controlling the positioning means for positioning the mapping detector at or adjacent to a plurality of inspection locations, for operating the first and second electromagnetic transducer in order to measure a conductivity pattern along the surface, for determining from the conductivity pattern the defect pattern that includes defect locations and/or defect geometries along the surface, for selecting from the defect pattern the defect associated with the individual crack to be sized and determining the location of that defect, for controlling the positioning means for positioning the sizing detector at or adjacent to the individual crack to be sized, and for operating the exciting laser and detection laser for determining the depth of the individual crack to be sized.
